(19) United States
(12) Patent Application Publication
(10) Pub. No.: US 2004/0105804 A1
(43) Pub. Date: Jun. 3, 2004

(54) Catalyst for water-gas shift reaction and method for converting carbon monoxide and water to hydrogen and carbon dioxide

(75) Inventors: Chiou-Hwang Lee, Hsinchu (TW); Chiung-Hui Huang, Hsinchu (TW); Li-Pin Chu, Hsinchu (TW); Ching-Tang Lin, Hsinchu (TW)

Correspondence Address: BACON & THOMAS, PLLC, 625 SLATERS LANE, FOURTH FLOOR, ALEXANDRIA, VA, 22314

(73) Assignee: Industrial Technology Research Institute, Hsinchu (TW)

(21) Appl. No.: 10/701,530

(22) Filed: Nov. 6, 2003

(30) Foreign Application Priority Data
Nov. 29, 2002 (TW) 91134887

(51) Int. Cl. B01J 23/60

(52) U.S. Cl. 423/247; 502/313; 502/329; 502/331

(57) ABSTRACT

The present invention discloses a catalyst useful in converting carbon monoxide and water to hydrogen and carbon dioxide (water gas shift reaction), which includes a metal oxide carrier and 0.1-10% Pt and 0-5% Re supported on the carrier, based on the weight of the carrier. The carrier contains copper oxide, alumina, and a metal oxide selected from zinc oxide, chromium oxide and magnesium oxide. The present invention also discloses a method for reducing the content of carbon monoxide in a hydrogen-rich reformate gas.

### FIELD OF THE INVENTION

The present invention relates to a method for converting carbon monoxide (CO) and water to hydrogen and carbon dioxide (CO₂), i.e. the water-gas shift reaction, and in particular to a catalyst used therein.

### BACKGROUND OF THE INVENTION

Polymer electrolyte membrane fuel cells (PEMFCs) are likely to be used in a stationary domestic electricity generation system or an electric automobile. The fuel required by a PEMFC system is a hydrogen-rich gas with a CO concentration lower than 20 ppm (H₂ concentration>35%). A hydrogen-rich reformate gas with a CO concentration of about 8˜15% generated by a reforming reaction from a hydrocarbon is proceeded with a water gas shift reaction (abbreviated hereinafter as WGS) in order to reduce the CO concentration below 1%, followed by a selective oxidation to further reduce the CO concentration below 20 ppm. In the past, one of the WGS catalysts used was Cu—ZnO/Al₂O₃. Its major drawbacks include a narrow reaction temperature range, requiring activation, requiring stored in an air-free environment, and a poor heat resistance. Due to these drawbacks, the conventional Cu—ZnO/Al₂O₃ catalyst is not suitable for use in a fuel reformer system of a stationary domestic fuel cell electricity generation system.

Therefore, catalyst researchers are aggressively developing a WGS reaction catalyst more suitable for use in the fuel cell electricity generation system. For example, in U.S. Pat. No. 6,238,640, Idemitsu Kosan has developed Cu—MO—Al₂O₃ (wherein M is Zn, Cr, or Mg); in EP 1,161,991, Matsushita Electric Works, Ltd. has developed Pt—M/ZrO₂ (wherein M is Re, Sc, or Pr); in EP 1,184,445, Toyota has developed Pt—M/TiO₂ (wherein M is Al, Si, P, S, or V); and Nextech has developed a Pt/CeO₂—ZrO₂ catalyst for use in the WGS reaction. They all claim that these catalysts are relatively stable with air (oxygen) and have a very high activity in catalyzing the WGS reaction. In fact, however, the abovementioned catalysts each have its own defects. For example, the catalyst developed by Idemitsu Kosan has a poor catalyst activity; and the catalysts developed by the Matsushita Electric Works, Ltd. and Toyota have a high content of precious metal (the concentration of Pt being 3˜12 wt % in the examples of the patents) which contributes to a high synthesis cost for the catalysts.

### SUMMARY OF THE INVENTION

One objective of the present invention is to provide a catalyst that can be used to convert carbon monoxide and water into hydrogen and carbon dioxide (WGS reaction). Said catalyst has a high CO conversion ratio and a low production cost.

Another objective of the present invention is to provide a method for converting carbon monoxide and water into hydrogen and carbon dioxide.

Still another objective of the present invention is to provide a method for reducing the content of carbon monoxide and increasing the content of hydrogen in a hydrogen-rich reformate gas.

In order to accomplish the aforesaid objectives of the present invention, a catalyst for converting carbon monoxide and water into hydrogen and carbon dioxide synthesized according to the present invention comprises a metal oxide carrier, which comprises a copper oxide, an aluminum oxide, and a metal oxide selected from the group consisting of zinc oxide, chromium oxide and magnesium oxide, characterized in that said catalyst further comprises 0.1-10% of platinum (Pt), preferably 0.5-5% of Pt, and 0-5% of rhenium (Re), preferably 0.1-3% of Re, supported on said metal oxide carrier, based on the weight of said metal oxide carrier.

The present invention also discloses a method for converting carbon monoxide (CO) and water into hydrogen and carbon dioxide (CO₂), which comprises contacting a hydrogen-rich gas feed containing hydrogen, CO and steam with the abovementioned catalyst according to the present invention at 100˜500° C.

Preferably, the metal oxide carrier of the catalyst of the present invention comprises a copper oxide, an aluminum oxide, and a zinc oxide, wherein said metal oxide carrier comprises 25-55% of copper, based on the weight of said metal oxide carrier.

Preferably, said hydrogen-rich gas feed used in the method of the present invention is a hydrogen-rich reformate gas formed by reforming a hydrocarbon.

Preferably, said hydrogen-rich gas feed used in the method of the present invention comprises more than 30 mole % of hydrogen, and a mole ratio of H₂O to CO is 2-10.

### BRIEF DESCRIPTION OF THE DRAWINGS

FIG. 1 is a plot of the CO conversion ratio vs. the inlet temperature of gas feed having a H₂O/CO mole ratio of 3 in a WGS reaction, wherein the round dots represent the results of the catalyst prepared in Example 1 of the present invention; the circles represent the catalyst prepared in Control Example 1; and the solid rhombuses represent the catalyst prepared in Control Example 2.

FIG. 2 is a plot of the CO conversion ratio vs. the inlet temperature of gas feed having a H₂O/CO mole ratio of 6 in a WGS reaction, wherein the hollow rhombuses represent the results of the catalyst prepared in Example 1 of the present invention; the round dots represent the catalyst prepared in Example 2 of the present invention; the circles represent the catalyst prepared in Example 3 of the present invention; and the triangular dots represent the catalyst prepared in Control Example 3.

FIG. 3 is a plot of the CO conversion ratio vs. the inlet temperature of gas feed having a H₂O/CO mole ratio of 4 in a WGS reaction, wherein the round dots and the circles respectively represent the results of the catalyst prepared in Example 2 of the present invention before aging and after aging (400° C., 20 hours); and the triangle dots and the triangles respectively represent the catalyst prepared in Control Example 3 before aging and after aging (400° C., 20 hours.

FIG. 4 is a plot of the CO conversion ratio vs. the inlet temperature of gas feed having a H₂O/CO mole ratio of 6 in a WGS reaction, wherein the round dots represent the results of the catalyst prepared in Example 2 of the present invention; the triangle dots represent the catalyst prepared in Control Example 4; the rectangular dots represent the catalyst prepared in Control Example 5.

### DETAILED DESCRIPTION OF THE INVENTION

The present invention discloses a catalyst for the WGS reaction, which can avoid the drawbacks of the conventional Cu—ZnO/Al₂O₃ catalyst, while having an activity for the WGS reaction higher than or comparable to the activity of the above-mentioned catalysts developed by Matsushita Electric Works, Ltd., Nextech, and Toyota. Furthermore, the concentration of the precious metal in the catalyst of the present invention is reduced, and thus the synthesis cost of the catalyst of the present invention is reduced. A comparison between the catalysts disclosed in the prior art and the catalysts synthesized according to the preferred embodiments of the present invention is listed in the following table:

| | | Matsushita | | |
|---|---|---|---|---|
| | | Electric Works, | | |
| | Toyota | Ltd. | Idemitsu Kosan | Present |
| | EP 1184445 | EP 1161991 | US 6238640 | invention |
| Catalyst | Pt-M/TiO₂ | Pt-M/ZrO₂ | Cu-M/Al₂O₃ | Pt-Re/Cu-Zn-Al |
| Composition | M: Al, Si, P, S, V | M: Re, Sc, Pr | M: Zn, Cr, Mg | |
| Content of | 3-12 wt % | 3 wt% | — | 1-3 wt% |
| precious | | | | |
| metal | | | | |
| Reactivity | High | high | Medium | High |
| Capable of | Yes | Yes | Yes | Yes |
| contacting | | | | |
| oxygen | | | | |
| Cost of | High | High | Low | Medium |
| synthesis | | | | |

The present invention can be further understood by the following examples which are for illustrative only and not for limiting the scope of the present invention.

### EXAMPLE 1

34.2 g Cu(NO₃)₂.3H₂O, 92.7 g Al(NO₃)₃.9H₂O and 30.6 g Zn(NO₃)₂.6H₂O were dissolved in 1500 ml of deionized water. 28% of ammonium water was dripped into the resulting solution until the pH value of the solution was 7.5, while stirring at room temperature. The solution was stirred at room temperature for 2 hours, and then the gel formed in the solution was filtered out and washed with water, followed by drying at 120° C. for 12 hours and baked at 500° C. for 5 hours to obtain CU/Al₂O₃—ZnO having a weight ratio of Cu:Al₂O₃:ZnO=30:42:28.

To 20 g of a powder of the Cu/Al₂O₃—ZnO prepared a Pt(NH₃)₂(NO₂)₂ solution containing 0.2 g of Pt was added while stirring in a suitable volume so that an incipient wetness impregnation was carried out. The mixture was then dried at 120° C. for 12 hours, and then baked at 400° C. for 2 hours to obtain a Pt/Cu/Al₂O₃—ZnO catalyst, wherein the concentration of Pt is 1 wt %.

Powder of the Pt/Cu/Al₂O₃—ZnO catalyst prepared above and an alumina sol were mixed at a weight ratio of 9:1, during which a suitable amount of water was added to adjust the solid content thereof. After grinding, the viscosity of the resulting slurry was adjusted. Next, the slurry was coated on a ceramic honeycomb support having a volume having a diameter of 2 cm and a length 2 cm with a cell density of 400 cells/in². Subsequently, the catalyst/support was dried at 120° C. for 12 hours, and calcined at 450° C. for 2 hours to obtain a monolith honeycomb catalyst. The amount of the Pt/Cu/Al₂O₃—ZnO catalyst coated was about 1-2 g.

### CONTROL EXAMPLE 1

The steps of Example 1 were repeated to prepare a monolith honeycomb catalyst. However, a Pt-free Cu/Al₂O₃—ZnO powder was used to replace said Pt/Cu/Al₂O₃—ZnO powder in the coating step.

### CONTROL EXAMPLE 2

114 g Cu(NO₃)₂.3H₂O, 102 g Al(NO₃)₃.9H₂O and 309 g Zn(NO₃)₂.6H₂O were dissolved in 3000 ml of deionized water. 28% of ammonium water was dripped into the resulting solution until the pH value of the solution was 7.5, while stirring at room temperature. The solution was stirred at room temperature for 2 hours, and then the gel formed in the solution was filtered out and washed with water, followed by drying at 120° C. for 12 hours and baked at 500° C. for 5 hours to obtain Cu/Al₂O₃—ZnO having a weight ratio of Cu:Al₂O₃:ZnO=23.4:10.8:65.8. Next, powder of this Cu/Al₂O₃—ZnO was used to prepare a monolith honeycomb catalyst by repeating the coating, drying and calcining steps in Example 1.

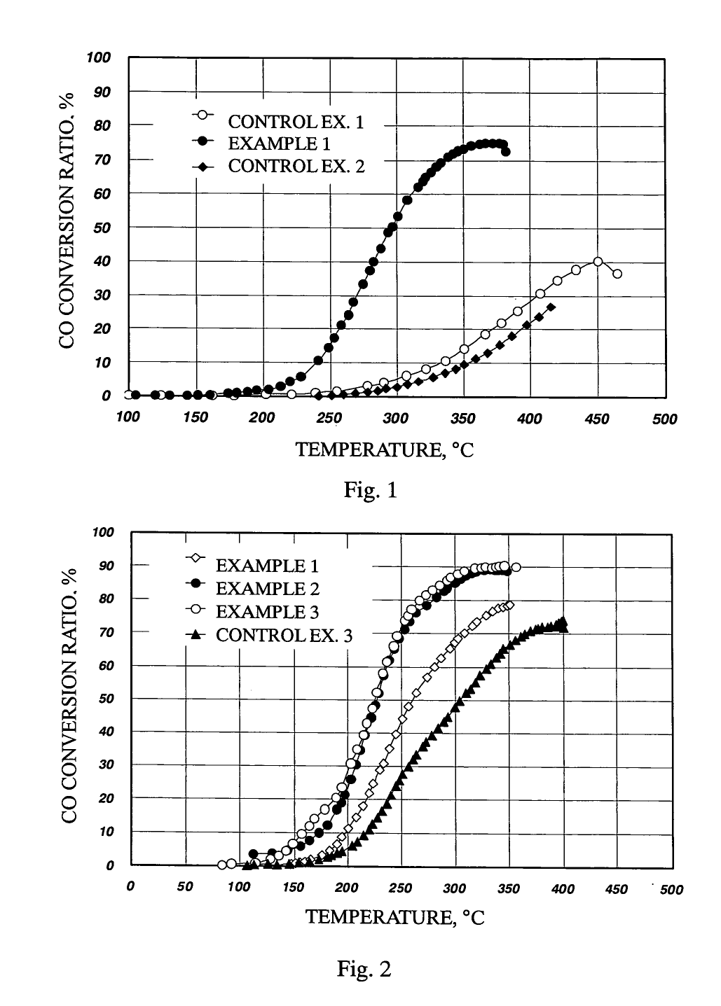

The conventional fixed-bed catalytic reactor was used for testing the activity of the catalysts in the WGS reaction. The honeycomb catalysts were separately loaded into a quartz reaction tube having an inner diameter of 2.2 cm. The inlet temperature of the gas feed was controlled by an electric heating furnace. The gas feed contained 50.2% H₂, 9.4% CO, 12.2% CO₂, and 28.2% H₂O, wherein H₂O/CO molar ratio was 3. The space velocity of the gas feed (GHSV) was 7000⁻¹ hr. The results are shown in FIG. 1. The experimental data of FIG. 1 show that a further deposition of Pt on the Cu/Al₂O₃—ZnO catalyst greatly increases the catalytic activity to the WGS reaction, thereby increasing the CO conversion ratio.

### EXAMPLE 2

151.02 g Cu(NO₃)₂.3H₂O, 214.31 g Al(NO₃)₃.9H₂O and 72.0 g Zn(NO₃)₂.6H₂O were dissolved in 3000 ml of deionized water. 28% of ammonium water was dripped into the resulting solution until the pH value of the solution was 7.5, while stirring at room temperature. The solution was stirred at room temperature for 2 hours, and then the gel formed in the solution was filtered out and washed with water, followed by drying at 120° C. for 12 hours and baked at 500° C. for 5 hours to obtain Cu/Al₂O₃—ZnO having a weight ratio of Cu:Al₂O₃:ZnO=45:33:22.

The Cu/Al₂O₃—ZnO was ground into powder. To 20 g of the Cu/Al₂O₃—ZnO powder a Pt(NH₃)₂(NO₂)₂ solution containing 0.2 g of Pt and a NH₄ReO₄ solution containing 0.2 g of Re were added while stirring in a suitable volume so that an incipient wetness impregnation was carried out. The mixture was then dried at 120° C. for 12 hours, and then baked at 400° C. for 2 hours to obtain a Pt—Re/Cu/Al₂O₃—ZnO catalyst, wherein both the concentrations of Pt and Re are 1 wt %. Next, powder of this Pt—Re/Cu/Al₂O₃—ZnO was used to prepare a monolith honeycomb catalyst by repeating the coating, drying and calcining steps in Example 1. The amount of the Pt—Re/Cu/Al₂O₃—ZnO catalyst coated was about 2 g.

### EXAMPLE 3

The steps of Example 2 were repeated to prepare a monolith honeycomb catalyst of Pt—Re/Cu/Al₂O₃—ZnO, except that the Pt—Re/Cu/Al₂O₃—ZnO powder contains 3 wt % of Pt and 1 wt % of Re. The monolith honeycomb catalyst contained about 2 g of the Pt—Re/Cu/Al₂O₃—ZnO catalyst.

### CONTROL EXAMPLE 3

A monolith honeycomb catalyst of Cu/Al₂O₃—ZnO catalyst was prepared by repeating the procedures in Example 2, except that a Cu/Al₂O₃13 ZnO catalyst without deposition of Pt and Re was used to replace the Pt—Re/Cu/Al₂O₃—ZnO catalyst.

The conventional fixed-bed catalytic reactor was used for testing the activity of the catalysts in the WGS reaction. The honeycomb catalysts were separately loaded into a quartz reaction tube having an inner diameter of 2.2 cm. The inlet temperature of the gas feed was controlled by an electric heating furnace. The gas feed contained 33.8% H₂, 5.4% CO, 10.2% CO₂, and 32.4% H₂O, wherein H₂O/CO molar ratio was 6. The space velocity of the gas feed (GHSV) was 6000⁻¹ hr. FIG. 2 shows the results of the catalysts prepared in Examples 1 to 3 and Control Example 3. The experimental data of FIG. 2 show that a further deposition of Re on the Pt/Cu/Al₂O₃—ZnO catalyst enhances the catalytic activity to the WGS reaction, thereby increasing the CO conversion ratio. Furthermore, the Pt—Re/Cu/Al₂O₃—ZnO catalyst has a CO conversion ratio significantly higher than that of the Cu/Al₂O₃—ZnO catalyst.

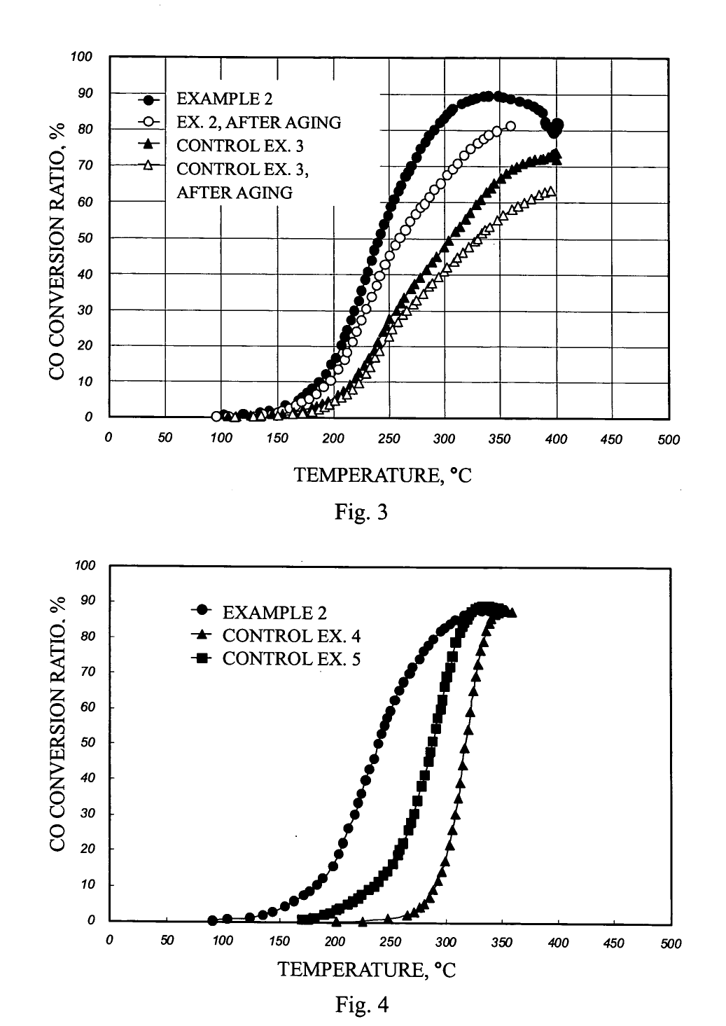

Similarly, the conventional fixed-bed reaction system was used to test the activities of the catalysts after aging in the WGS reaction. The monolith honeycomb catalysts prepared in Example 2 and Control Example 3 were subjected to an aging treatment at 400° C. for 20 hours. The composition of the gas feed was changed to H₂ 47.3%, CO 8.1%, CO₂ 12.2%, and H₂O 32.4%, with a H₂O/CO mole ratio of 4. FIG. 3 shows the conversion ratio of the monolith honeycomb catalysts (before and after aging) of Example 2 and Control 3 at different inlet temperatures of the gas feed. The experimental data of FIG. 3 indicate that, after being aged at 400° C. for 20 hours, the CO conversion ratio of the Pt—Re/Cu/Al₂O₃—ZnO catalyst will decrease but still higher than that of the conventional Cu/Al₂O₃—ZnO catalysts with or without aging.

### CONTROL EXAMPLE 4

An incipient wetting impregnation was carried out to prepare a Pt—Re/ZrO₂ catalyst having 3 wt % Pt and 1 wt % Re, based on the weight of the ZrO₂ powder, including drying the powder/solution mixture at 120° C. for 12 hours and then baking at 400° C. for 2 hours. The powder of the resulting Pt—Re/ZrO₂ was mixed with an alumina sol at a weight ratio of 9:1, during which a suitable amount of water was added to adjust the solid content thereof. After grinding, the viscosity of the slurry was adjusted. Next, the slurry was coated on a ceramic honeycomb support having a diameter of 2 cm, and a length of 2 cm with a cell density of 400 cells/in². Subsequently, the catalyst/support was dried at 120° C. for 12 hours, and calcined at 400° C. for 2 hours to obtain a monolith honeycomb catalyst. The amount of the Pt—Re/ZrO₂ catalyst coated was about 2 g

### CONTROL EXAMPLE 5

A Pt/CeO₂—ZrO₂ powder (containing 2 wt % of Pt, based on the weight of the CeO₂—ZrO₂ powder) purchased from the Nextech Co. was mixed with 10 wt % of an alumina sol binder. A suitable amount of water was added to adjust the solid content of the resulting mixture. After grinding, the viscosity of the slurry was adjusted. Next, the slurry was coated on a ceramic honeycomb support having a diameter of 2 cm, a length of 2 cm, and a cell density of 400 cells/in². The coated support was dried at 120° C. for 12 hours, and baked at 400° C. for 2 hours, to obtain a monolith honeycomb catalyst. The monolith honeycomb catalyst was coated with about 2 g of the Pt/CeO₂—ZrO₂ catalyst.

Similarly, the conventional fixed-bed reaction system was used to test the activities of the honeycomb catalysts prepared in Example 2, Control Examples 4 and 5 in the WGS reaction. The composition of the gas feed was H₂ 33.8%, CO 5.4%, CO₂ 10.2%, N₂ 18.2%, and H₂O 32.4%, with a H₂O/CO mole ratio of 6. The space velocity of the gas feed (GHSV) was 6000-1 hr. The experimental data contained in FIG. 4 show that the highest CO conversion ratio of the Pt—Re/Cu/Al₂O₃—ZnO catalyst is comparable to the catalysts of Control Examples 4 and 5. However, the gas feed temperature of the Pt—Re/Cu/Al₂O₃—ZnO catalyst is lower, and the content of precious metal thereof is also lower compared to the catalysts of Control Examples 4 and 5. The experimental data indicate that the Pt—Re/Cu/Al₂O₃—ZnO catalyst has an excellent catalytic performance in the WGS reaction.

What is claimed is:

1. An catalyst suitable for converting carbon monoxide and water to hydrogen and carbon dioxide comprising a metal oxide carrier comprising a copper oxide, an aluminum oxide, and a metal oxide selected from the group consisting of zinc oxide, chromium oxide, and magnesium oxide, characterized in that said catalyst further comprises, supported on said metal oxide carrier, 0.1-10% platinum (Pt) and 0-5% rhenium (Re), based on the weight of said metal oxide carrier.

2. The catalyst as claimed in claim 1, wherein said metal oxide carrier comprises a copper oxide, an aluminum oxide, and a zinc oxide, wherein said metal oxide carrier comprises 25-55% copper, based on the weight of said metal oxide carrier.

3. The catalyst as claimed in claim 1, wherein said catalyst comprises 0.5-5% Pt, based the weight of said metal oxide carrier.

4. The catalyst as claimed in claim 3, wherein said catalyst comprises 0.1-3% Re, based on the weight of said metal oxide carrier.

5. A method for converting CO and water to hydrogen and CO₂, which comprises contacting a hydrogen-rich gas feed containing CO and steam with said catalyst as claimed in claim 1 at 200˜500° C.

6. The method as claimed in claim 5, wherein said hydrogen-rich gas feed is a hydrogen-rich reformate gas formed by reforming a hydrocarbon.

7. The method as claimed in claim 5, wherein said hydrogen-rich gas feed comprises more than 30 mole % of hydrogen, and the mole ratio of H₂O to CO is 2-10.

8. The method as claimed in claim 5, wherein the metal oxide carrier of said catalyst comprises a copper oxide, an aluminum oxide, and a zinc oxide, wherein said metal oxide carrier comprises 25-55% copper, based on the weight of said metal oxide carrier.

9. The method as claimed in claim 5, wherein said catalyst comprises 0.5-5% Pt, based on the weight of said metal oxide carrier.

10. The method as claimed in claim 9, wherein said catalyst comprises 0.1-3% Re, based on the weight of said metal oxide carrier.
